(19) United States
(12) Patent Application Publication
(10) Pub. No.: US 2026/0310822 A1
(43) Pub. Date: Oct. 8, 2026

(54) COMPUTING TECHNOLOGIES FOR PRIVACY-PRESERVING SERVICE OF DATA BASED ON ZERO-KNOWLEDGE PROOFS

(71) Applicant: Datasent, Inc., Austin, TX (US)

(72) Inventor: Gregory Allen, Austin, TX (US)

(21) Appl. No.: 19/705,091

(22) Filed: Jun. 11, 2026

Related U.S. Application Data
(63) Continuation of application No. PCT/US2024/060108, filed on Dec. 13, 2024.
(60) Provisional application No. 63/610,905, filed on Dec. 15, 2023.

(51) Int. Cl. G06F 21/62; G06F 16/22; H04L 9/32

(52) U.S. Cl. CPC G06F 21/6245; G06F 16/2246; H04L 9/3218

(57) ABSTRACT

This enables various computing technologies for privacy-preserving service of data based on ZKPs. As such, these technologies enable a server to serve a content over a network to an application hosted on an OS of a client operated by a user, where the content may be customized for the user based on various privacy-preserving algorithms involving ZKPs, while minimizing or eliminating at least some access for third parties to personal information of the user.

### CROSS-REFERENCE TO RELATED PATENT APPLICATIONS

This patent application is a Continuation of International Application PCT/US2024/060108 filed 13 Dec. 2024; which claims a benefit of priority to U.S. Provisional Patent Application 63/610,905 filed on 15 Dec. 2023; each of which is incorporated by reference herein for all purposes.

### TECHNICAL FIELD

This disclosure relates to Zero-Knowledge Proofs (ZKPs).

### BACKGROUND

A server may serve a content (e.g., an image) over a network to an application (e.g., a browser application) hosted on an operating system (OS) of a client (e.g., a stationary computer) operated by a user. The content may be customized (e.g., targeted) for the user based on personal information (e.g., in its raw state) thereof for consumption of the content on the client. As such, the server may access a profile for the user formed based on the personal information and serve the content by customizing the content according to the profile for the user. Although this modality of computing may be sufficient in some situations, there are still some technical problems associated with this modality of computing. For example, if the user is sensitive about third parties (e.g., data brokers) having access to the personal information, then, for privacy purposes, the user may desire to minimize sharing the personal information for such customization of the content, yet still have access to the content. Likewise, the user may share the personal information that may be fake or inaccurate, thereby reducing at least some effectiveness of the content being customized.

### SUMMARY

This disclosure solves the technical problems identified above by enabling various computing technologies for privacy-preserving service of user data based on ZKPs. As such, these technologies enable the server to serve the content over the network to the application hosted on the OS of the client operated by the user, where the content may be customized for the user based on various privacy-preserving algorithms involving the ZKPs, while minimizing or eliminating at least some access for the third parties to the personal information of the user.

### DESCRIPTION OF DRAWINGS

FIG. 1 shows a diagram of an embodiment of a computing architecture enabling a privacy-preserving service of data based on ZKPs according to this disclosure.

FIG. 2 shows a flowchart of an embodiment of an algorithm enabling the privacy-preserving service of data based on ZKPs using the computing architecture of FIG. 1 according to this disclosure.

FIG. 3 shows a diagram of an embodiment of a computing arrangement enabling the privacy-preserving service of data based on ZKPs using the computing architecture of FIG. 1 and the algorithm of FIG. 2 according to this disclosure.

FIG. 4 shows a diagram of an embodiment of a set of data permissions for the computing architecture enabling the privacy-preserving service of data based on ZKPs using the computing architecture of FIG. 1, the algorithm of FIG. 2, and the computing arrangement of FIG. 3 according to this disclosure.

### DETAILED DESCRIPTION

As explained above, this disclosure solves the technical problems identified above by enabling various computing technologies for privacy-preserving service of user data based on ZKPs. As such, these technologies enable the server to serve the content over the network to the application hosted on the OS of the client operated by the user, where the content may be customized for the user based on various privacy-preserving algorithms involving the ZKPs, while minimizing or eliminating at least some access for the third parties to the personal information of the user.

This disclosure is now described more fully with reference to various figures that are referenced above, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled persons.

Various terminology used herein can imply direct or indirect, full or partial, temporary or permanent, action or inaction, individual or collective. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes,” “contains,” “has,” or “comprising,” “including,” “containing,” or “having” (or any forms or tenses thereof) when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

As used herein, a term “about” or “substantially” refers to a +/−10% variation from a nominal value/term. Such variation is always included in any given value/term provided herein, whether or not such variation is specifically referred thereto.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled persons understand that typically there is no limit on a number of items or terms in any combination, unless otherwise contextually apparent.

Features or functionality described with respect to certain embodiments may be combined or sub-combined in or with various embodiments in any permutational or combinatorial manner. Different aspects or elements of embodiments, as disclosed herein, may be combined or sub-combined in a similar manner. A skilled person will understand that typically there is no limit on a number of items or terms in any combination, unless otherwise contextually apparent

Some embodiments, whether individually or collectively, can be components of a larger system, where other procedures can take precedence over or otherwise modify their application. Additionally, a number of steps can be required before, after, or concurrently with embodiments, as disclosed herein. Note that any or all methods or processes, at least as disclosed herein, can be at least partially performed via at least one entity in any manner.

Some embodiments are described herein with reference to illustrations of idealized embodiments (and intermediate structures) of this disclosure. As such, variations from various illustrated shapes as a result, for example, of manufacturing techniques or tolerances, are to be expected. Thus, various embodiments should not be construed as necessarily limited to various particular shapes of regions illustrated herein, but are to include deviations in shapes that result, for example, from manufacturing.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

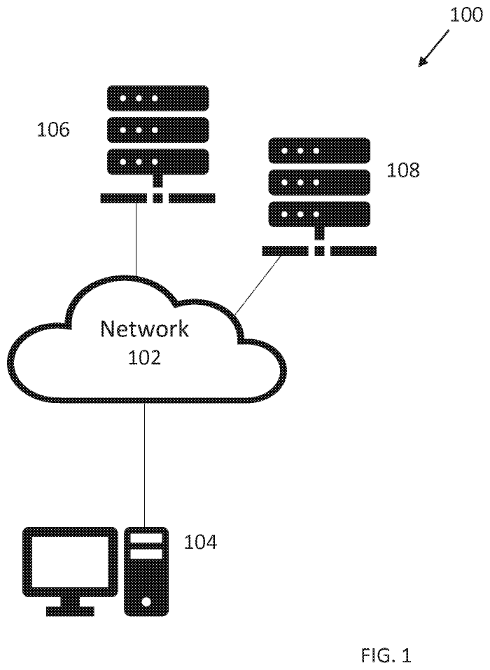

FIG. 1 shows a diagram of an embodiment of a computing architecture enabling a privacy-preserving service of data based on ZKPs according to this disclosure. In particular, there is a computing architecture 100 containing a network 102, a computing terminal 104, a first computing instance 106, and a second computing instance 108.

The network 102 is a single network or a set of networks. For example, the network 102 may include a Local Area Network (LAN), a Wide Area Network (WAN), a satellite network, a cellular network, a storage area network, or another suitable network. For example, the network 102 may include Internet.

The computing terminal 104 hosts an OS (e.g., Windows, MacOS, Android) running an application thereon. For example, the application may be a browser application (e.g., Firefox, Chrome, Edge, Opera, Safari), a dedicated content application (e.g., a mobile app), or another suitable application. The computing terminal 104 communicates with the network 102. The computing terminal 102 may have a form factor of a desktop computer, a laptop computer, a wearable computer, a smartphone, or another suitable computing terminal. The computing terminal 104 is operated by a human user. For example, the computing terminal 104 may have a single processing unit (e.g., a single or multi core processor) or a set of processing units (e.g., a set of single or multi core processors). Although FIG. 1 shows the computing terminal 104 as a sole computing terminal 104, this configuration is not required and there may be a set of computing terminals 104, each operating similar to the computing terminal 104 described above.

The first computing instance 106 is a physical server(s) hosting an OS (e.g., Windows, Linux) and an application running thereon. The application is programmed to enable a privacy-preserving service of data based on ZKPs, as disclosed herein. The first computing instance 106 communicates with the network 102. For example, the application of the first computing instance 106 communicates with the application of the computing terminal 104 over the network 102. When the first computing instance 106 is a set of servers, then the application of the first computing instance 106 may be distributively hosted over the set of servers. For example, the first computing instance 106 may have a single processing unit (e.g., a single or multi core processor) or a set of processing units (e.g., a set of single or multi core processors). The first computing instance 106 is operated by an manufacturer of the application of the first computing instance 106 programmed to enable the privacy-preserving service of data based on ZKPs, as disclosed herein.

The second computing instance 108 is a physical server(s) hosting an OS (e.g., Windows, Linux) and an application running thereon. The application is programmed to enable the privacy-preserving service of data based on ZKPs, as disclosed herein. The second computing instance 108 communicates with the network 102. For example, the application of the second computing instance 108 communicates with the application of the first computing instance 106 or the application of the computing terminal 104 over the network 102. When the second computing instance 108 is a set of servers, then the application of the second computing instance 108 may be distributively hosted over the set of servers. For example, the second computing instance 108 may have a single processing unit (e.g., a single or multi core processor) or a set of processing units (e.g., a set of single or multi core processors). The second computing instance 106 is operated by a content distributer (e.g., an Internet advertiser, an agency serving ads, an ad manager, an ad exchange, a website operator) using the application of the first computing instance 106 to enable the privacy-preserving service of data based on ZKPs, as disclosed herein.

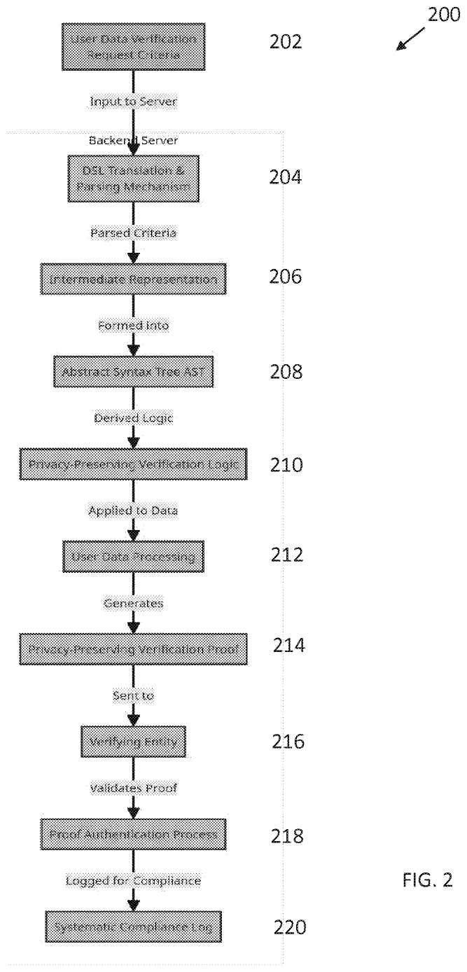

FIG. 2 shows a flowchart of an embodiment of an algorithm enabling the privacy-preserving service of data based on ZKPs using the computing architecture of FIG. 1 according to this disclosure. In particular, there is an algorithm (e.g., a method, a process) 200 having a step of steps 202-220 that performed using the computing architecture 100 shown in FIG. 1, whether in a sequence of steps as shown in FIG. 2 or in another sequence. For example, the algorithm 200 may be collectively performed by the computing terminal 104, the first computing instance 106, and the second computing instance 108 over the network 102.

The algorithm 200 is applicable to various use cases. For example, in many industries, data resides across multiple distributed sources, such as databases, user devices, or organizational silos. Moving raw data across systems poses privacy and compliance challenges. As such, the algorithm 200 enables secure information extraction and analysis by tokenizing raw data at its source and aggregating those tokenized features. For example, there may be tension between a first desire to target or customize ads accurately (e.g., requiring detailed user data) and a second desire to protect user privacy. In particular, traditional advertising methods may involve sharing or exposing user data, often leading to privacy breaches and non-compliance with data protection regulations. As such, the algorithm 200 may enable an advertiser to ensure that an ad is targeted or customized for a user based on specific criteria (e.g., estimated demographic data) without actually accessing a set of raw user data (e.g., actual demographic data). For example, the algorithm 200 may ensure data privacy by transforming raw data into tokenized outputs from arithmetic circuit logic computations, while addressing the loss of granularity by incorporating multi-attribute feature extraction, hierarchical representations, and context-aware refinements, with no direct exposure of raw data, with minimal loss of detail.

In step 202, the first computing instance 106 receives a request (e.g., a message, a data packet, a payload) for a set of criteria to verify a set of user data (e.g., demographics, preferences, interests, likes, dislikes, estimated sentiment, estimated emotion) associated with the user operating the computing terminal 104 over the network 102. The request may be received from the application of the computing terminal 104 or the application of the second computing instance 108. For example, the processing unit of the computing instance 106 may receive a request to enable a verification of an attribute (e.g., a demographic characteristic, a shopping preference) of a set of attributes of a profile of a user. For example, the user may be operating the computing terminal 104. For example, the first computing instance 106 may be a physical server machine, where the request is sent by a physical client machine (e.g., a stationary computer, a mobile computer, a wearable computer) operated by the user.

In step 204, since the request may be submitted in a Domain-Specific Language (DSL), such as Standard Query Language (SQL), regular expressions, configuration files, or Hypertext Markup Language (HTML), the first computing instance 106 performs (a) a DSL translation process (e.g., via an interpreter program) on the request to form a translation that can be further textually processed and (b) a parsing process (e.g., by an attribute) on the translation to form a set of criteria (e.g., a set of attributes) associated with the request. For example, the processing unit of the computing instance 106 may parse the request, as translated, into a set of criteria (e.g., a set of attribute tokens) responsive to the processing unit receiving the request.

In step 206, the first computing instance 106 forms an intermediate representation of the request based on the set of criteria. For example, the intermediate representation may be a Directed Acyclic Graph (DAG), a linear representation (e.g., a tuple, a quad), a Static Single Assignment (SSA) Form, or a stack-based representation. The intermediate representation provides optimization (e.g., constant folding), modularity (e.g., front-end parsing, middle-end optimization, back-end code generation), or retargetability (e.g., support multiple content types and target architectures efficiently).

In step 208, the first computing instance 106 forms an Abstract Syntax Tree (AST) or another suitable a hierarchical data structure. For example, the AST may represent an abstract syntactic structure of the intermediate representation in a tree-like representation where each node corresponds to a construct within the intermediate representation. As such, each node in the AST may represents a specific element of the intermediate representation's syntax, such as an arithmetic operation. Such nodes may contain textual information about a type of construct being represented and may have child nodes that represent a particular subcomponent. The AST may be technologically advantageous because the AST enables transformations, such as refactoring, due to a structured representation that can be manipulated programmatically. However, the AST is not required. For example, the hierarchical data structure may be a parse tree, such as a concrete parse tree (CPT) or a concrete syntax tree (CST). The parse tree may be technologically advantageous when a syntactic structure of the intermediate representation is desired in more detail than the AST provides.

In step 210, the first computing instance 106 derives a circuit logic (e.g., use a non-Turing complete modular arithmetic logic that represents computations as arithmetic circuits using constraints) from the AST to form privacy-preserving verification logic. For example, the hierarchical data structure may be populated with the set of tokens on a node-by-node basis, which may start at a root node and the circuit logic may be generated based on the set of tokens being read on a node-by-node basis from the hierarchical data structure, where the circuit logic embodies a set of computations to verify the set of attributes. The set of computations can have a one-to-many correspondence with the set of attributes, a one-to-one correspondence with the set of attributes, a many-to-many correspondence with the set of attributes, or a many-to-one correspondence with the set of attributes. The first computing instance 106 may run an algorithm capable of programmatically generating specific instances of the circuit logic based on varying verification criteria and conditions and configuring the circuit logic for a ZKP, where the circuit logic is representative of an arithmetic computation pertaining to a user data verification process.

The circuit logic may contain a set of circuits expressing the set of computations that need to be verified without revealing a underlying data for a ZKP to be enabled, as further described below. For example, the set of circuits may be used to represent a logical structure of the set of computations that need to be verified. As such, the set of circuits may operate as or be a series of constraints over variables that define how inputs should be processed to produce outputs (e.g., a mathematical representation of a computation problem that needs to be proven). For example, the set of circuits may be expressed using constraint systems, such as a Rank-1 Constraint Systems (R1CS) or an Arithmetic Circuit Intermediate Representation (ACIR). In context of execution and constraints, note that a circuit in a ZKP may be used twice: first, to compute a “witness” or trace of all variable assignments given specific inputs, and second, to derive constraints that must hold true for a proof to be valid (this dual use highlights a separation between executing a computation and verifying its correctness through constraints). In context of proving and verifying, as further described below, note that such proving process involves generating a proof that all constraints within the set of circuits hold true for given inputs without revealing those inputs. Then, a verifier may check this proof using a verifying key, ensuring that no additional information is leaked beyond what is necessary.

The circuit logic may be a predetermined circuit logic. As such, in context of a ZKP, such as Zero-Knowledge Succinct Non-Interactive Argument of Knowledge (ZK-SNARK), a “circuit” refers to a computational blueprint representing a specific problem or verification process. For example, the ZK-SNARK is technologically advantageous due to zero-knowledge, succinctness, non-interactivity (e.g., does not require back-and-forth communication between a prover and a verifier and a single message from the prover suffices), and argument of knowledge, although the ZK-SNARK is not required and alternatives (e.g., Zero-Knowledge Scalable Transparent Argument of Knowledge (ZK-STARK)) may be used. For example, the SK-SNARK may be technologically advantageous due to speed increases based on its non-interactivity when real-time communication with content exchange platforms (e.g., image exchange platforms, video exchange platforms, ad exchange platforms) hosted on third-party computing systems for content service occurs, as described herein. However, alternatives to ZK-SNARK may be technologically advantageous in other scenarios (e.g., scalability, transparency, quantum resistance, computational cost-effectiveness). Regardless, this circuit is an arithmetic representation of a logic or computation that needs to be proved in a zero-knowledge manner. The predetermined circuit logic involves arithmetic gates, where basic operations, such as addition, subtraction, multiplication, and division are represented as gates in the circuit, and each gate performs a simple arithmetic function. The predetermined circuit logic involves inputs, which are the variables of the problem. In a ZKP context, inputs can be both public (known to both prover and verifier) and private (known only to the prover). The predetermined circuit logic involves outputs, which are the results of the computation, which should align with the expected proof or verification outcome. For example, in an age verification circuit, the inputs might be the user's birth date and the current date, the computation involves calculating the age, and the output is a Boolean result indicating whether the age meets the required threshold.

The determined circuit logic may be generated by an algorithm for programmatically creating such circuit logic, particularly for different types of verifications or computations. This algorithm provides flexibility, in that instead of manually creating a circuit for each specific problem, the algorithm can generate the required circuit based on predefined parameters or conditions. This makes the algorithm highly adaptable to various verification needs. This algorithm provides efficiency, in that the algorithm automates the process of circuit creation, which is desired for complex problems where manual circuit design would be impractical or error-prone. This algorithm provides standardization, in that the algorithm ensures consistency in how different proofs or verifications are structured, which is important for maintaining the integrity and reliability of a ZKP. Therefore, the algorithm is applied in context of ZKPs, in that when a new verification task arises (e.g., verifying a new type of user attribute for ad targeting), the algorithm takes the specifics of this task and automatically constructs the corresponding arithmetic circuit. This circuit is then used in the ZK-SNARK process or another alternative, where the prover generates a proof based on their private inputs and this circuit, and the verifier later checks the proof against the same circuit. For example, if the task is to verify user location within a certain region without revealing the exact geographical (or network) coordinates, then the algorithm designs a circuit that computes whether the user's location falls within the specified geographical (or network) parameters.

In step 212, the first computing instance 106 applies the circuit logic to user data to perform user data processing. This application may occur based on or responsive to the first computing instance 106 receiving verification requests for data verification over the network 102 from the computing terminal 104 (or the second computing instance 108 or other client devices or network entities), where each such request includes parameters defining the specific data verification to be performed. As such, the first computing instance 106 applies the circuit logic to the request parameters to dynamically generate a customized instance of the predetermined circuit logic tailored to the specific verification request. Accordingly, the first computing instance 106 processes the user data to be verified, where such processing adheres to the customized instance of the circuit logic and generates corresponding outputs without those outputs disclosing the actual user data. For example, the first computing instance 106 may solve a computation of the set of computations for the attribute such that a result related to the verification is formed and compare the result to the attribute or vice versa. For example, the result can be compared to the attribute or the attribute can be compared to the result. For example, the result may match the attribute or the attribute may match the result.

In step 214, the first computing instance 106 generates a ZKP based on the outputs of the circuit logic. The ZKP substantiates the truth of the verification claim (e.g., user attribute validity) without revealing the underlying data to the verifier in doing so. For example, the first computing instance 106 may generate a ZKP related to the verification for the result matching the attribute or vice versa without accessing the set of attributes. The ZKP may be non-interactive (faster), although the ZKP can be interactive (slower) as well.

In step 216, the computing terminal 104 or the first computing instance 106 sends the ZKP to the second computing instance 108 or the computing terminal 104 over the network 102. For example, the ZKP may be transmitted from the computing terminal 104 or the first computing instance 106 to the second computing instance 108 (a verifier entity) over the network 102, ensuring the confidentiality of the actual user data throughout the transmission.

In step 218, the computing terminal 104 or the first computing instance 106 enables or causes the second computing instance 108 to validate the ZKP via a ZKP authentication process. This validation may occur by verifying, by the verifier entity, the authenticity and accuracy of the ZKP against the same circuit logic instance, thereby confirming the verification claim without accessing the raw user data. For example, at this point, when the algorithm 200 is performed in context of internet advertising, the advertiser targeting criteria are translated into arithmetic circuit logic suitable for ZKPs, ensuring privacy-preserving advertisement targeting, without actually accessing the raw user data. For example, the computing terminal 104 or the first computing instance 106 may grant an access to the ZKP such that the attribute is verifiable at the second computing instance 108 based on the ZKP without the second instance 108 accessing the set of attributes and take an action (e.g., by the second computing instance 108) related to the verification based on the access without the second instance 108 accessing the set of attributes responsive to the request originally made by the second computing instance 108 to the computing terminal 104 or the first computing instance 106 over the network 102.

The ZKP may be authenticated before the access to the ZKP is granted. The ZKP may be authenticated by comparing the ZKP to the circuit logic or vice versa. A log may be modified by having a content (e.g., text) being written thereinto to memorialize the ZKP being authenticated.

The action may be include integrating the ZKP with a record for the user on a distributed ledger (e.g., a blockchain) such that a consent by the user related to the set of attributes is recorded in the record. The first computing instance 106 or the second computing instance 108 may cause a browser extension of a browser application program (e.g., Firefox, Chrome, Edge, Opera, Safari) hosted on the computing terminal 104 or a web application hosted on the second computing instance 108 to interface with a user application (e.g., a browser application program) hosted on the OS of the computing terminal 104 sourcing the request such that the browser extension or the web application present a notice related to the ZKP in the user application (e.g., within or over a viewport, within or over a menu bar, within or over an address bar, within or over an icon in a menu bar or an address bar). The notice may be or become visually distinct to grab the user's attention. The browser extension or the web application may be programmed to read the consent in the record, generate a copy of the consent, and present the copy in the user application for review by the user. The record may be a first record and the copy is modifiable by the user in the user application such that the copy as modified by the user in the user application is recordable in a second record on the distributed ledger after the first record (e.g., blocks in blockchain). The browser extension or the web application may be programmed to dynamically render a user interface in the user application in real-time based on the attribute being verified. The verification of the ZKP with the record may be performed such that the ZKP logically aligns with the consent. The ZKP may be a first ZKP and the verification may be a first verification. As such, the distributed ledger may be programmed to support a real-time update to the consent to allow for a second verification of a second ZKP based on the real-time update. The browser extension or web application may be programmed to notify the user application of a first result of the first verification in real-time and a second result of a second verification in real-time, where the action is based on the first result and the second result. The browser extension or the web application may be programmed to receive an input from the user in the user application (e.g., via a cursor control unit, a mouse, a physical keyboard, a virtual keyboard) and the browser extension or the web application coordinate such that the input is logically reflected in the ZKP (e.g., based on user input).

The first computing instance 106 or the second computing instance 108 may enable a computing machine (e.g., a server) of an operator of a website (e.g., a webpage) may act as a prover for the ZKP, where the website is associated with a data storage system providing an input for generating the ZKP (e.g., to enable an ad image or an ad video to be presented). The data storage system may include a database system, a customer relationship management (CRM) system, a content management system (CMS), a consent management platform (CMP), or a data management platform (DMP). The data storage system may stores a set of user data for a set of users. The set of user data may include a demographic information, a set of user preferences, or a set of consent records. The set of user data may include the profile. The set of users may include the user. The ZKP may be generated based on the data storage system enabling the set of user data to not be shared with the second computing instance 108. The data storage system may include the processing unit. The ZKP may be validated such that the profile is logically consistent with a set of specified criteria for a targeted service or an advertising campaign without revealing the set of user data to the computing machine of the operator of the targeted service or the advertising campaign. The computing machine of the operator of the website may be capable of using an outcome of validating the ZKP to customize a user experience of the website based on the set of user data that has been verified. For example, the user experience may include a personalized content delivery or a targeted advertisement. The data storage system and the first computing instance 108 may be are synchronized such that the ZKP is generated based on the attribute being up-to-date. The data storage system may be enabled to provide a user interface to manage the request enabling the ZKP to be generated.

Based on above, the circuit logic may be exemplified in one of such ways by the second computing instance 108 being programmed to target users in the New York region, aged between 25-35, who have shown interest in sports apparel in the past six months, purchased fitness equipment in the past year, and have an average browsing duration of more than 5 minutes on sports-related websites (or some other targeting criteria). This targeting breaks down into (1) the user is from the New York region, (2) the user is aged between 25 and 35, (3) the user has interest in sports apparel in the last six months, (4) the user purchased fitness equipment in the past year, and (5) the user has average browsing duration>5 minutes on sports-related sites. Therefore, given, x=User's age, y=Indicator for user's interest in sports apparel in the past six months (1 if true, 0 otherwise), z=Indicator for fitness equipment purchase in the last year (1 if true, 0 otherwise), t=Average browsing duration in minutes on sports-related sites, and r=Region code (e.g., 1 for New York, 0 otherwise), the circuit logic may be arithmetically embodied as (1) Region Validation: fr(r)=r and should be 1 for users from New York, (2) Age Validation: fa(x)=(x−25)(x−35) and should be negative if age is between 25 and 35, (3) Interest Validation: fi(y)=y and y will be 1 if the user has shown interest, 0 otherwise, (4) Purchase Validation: fp(z)=z and z will be 1 if the user made a purchase, 0 otherwise, and (5) Browsing Duration Validation: fd(t)=t−5 and should be positive if browsing duration is more than 5 minutes. The combined circuit for all these conditions will then be: f(x,y,z,t,r)=fr(r)×fa(x)×fi(y)×fp(z)×fd(t). For the user's data to be validated against the criteria: fr(r) should be positive, fa(x) should be negative, and fi(y), fp(z), and fd(t) should be positive. Hence, if f(x,y,z,t,r) is negative, the user matches the criteria.

In step 220, the first computing instance 106 enables or causes logging for compliance in a systematic compliance log. This logging may occur by storing information related to the proof generation and verification processes in a secure and compliant manner for audit and compliance purposes. Note that step 220 is optional.

As described above, the algorithm 200 may enable the first computing instance 106 to receive a request to verify an attribute of a user profile, whether from the computing terminal 104 or the second computing instance 106. This step involves network communication protocols, such as HTTP or gRPC, to transmit the request, which contains metadata about the attribute(s) to be verified. The first computing instance 106, configured with sufficient compute resources, parses the incoming request to ensure it adheres to predefined formats and security protocols, such as JSON schemas or XML validation. This ensures that the request is valid and ready for further processing. The request may be parsed into, where such parsing may involve a lexical analysis, where the input request is broken down into tokens—atomic units like keywords, identifiers, or symbols. For example, in programming languages, “age=25” might be tokenized into IDENTIFIER (age), EQUALS (=), and INTEGER (25). Such parsing may use algorithms like finite state machines to traverse the input string character by character and recognize patterns based on predefined grammar rules. The tokens are then organized into an Abstract Syntax Tree (AST), which a hierarchical representation of the logical structure of the input. Each node in the AST represents a construct from the input (e.g., an attribute or operation). For example, an AST for “age=25” might have a root node for ASSIGNMENT with child nodes for VARIABLE (“age”) and VALUE (“25”). This tree structure is created using parsing algorithms like LALR (Look-Ahead Left-to-Right). The AST is populated by associating each token with its corresponding node in the tree. This involves recursive traversal of the tree and mapping tokens to their respective positions based on syntax rules. For instance, if “age=25” is parsed, the tree's ASSIGNMENT node would be populated with child nodes for “age” and “25”. This step ensures that all tokens are logically grouped and ready for computation. Using the AST, the circuit logic is generated to represent computations as arithmetic circuits. These circuits are modular and non-Turing complete, meaning they use mathematical constraints to define operations without loops or recursion. Modular arithmetic may be employed here, where operations are performed within a fixed range (modulus). For example, verifying “age>18” could involve creating constraints like x−18>0x−18>0, where xx represents the age attribute. The first computing instance 106 executes the computations defined by the circuit logic to verify attributes. This involves solving arithmetic constraints using algorithms, such as Gaussian elimination or iterative solvers optimized for modular arithmetic. The result of these computations determines whether the attribute satisfies verification criteria. The computed result is compared against the expected attribute value using equality comparators implemented via logic gates, such as XNORs for binary inputs or more complex circuits for multi-bit comparisons. For example, if verifying “age=25”, an equality comparator checks if all bits of both values match. Then, a ZK-SNARK may be generated to prove that verification was successful without revealing sensitive data. The ZKP process may be involve a setup step where a trusted setup generates cryptographic parameters, a proof step where the prover uses these parameters and private data to create a proof, and a verification step where the verifier checks this proof against public parameters without accessing private data, which may occur at a later point in time. For example, ZK-SNARK may use elliptic curve cryptography to generate succinct proofs that are computationally efficient to verify, which is advantageous in real-time processing, such as during browsing operations (e.g., request-response server-client communication). Access to the generated ZKP may be granted through secure channels, such as public-key cryptography or blockchain-based systems where proofs can be stored and verified publicly. This step ensures that only authorized parties can access and use the proof for verification purposes. At this point, an action related to verification may be performed based on ZKP validation. For instance, the action may be granting access to restricted resources or allowing transactions on blockchain (or other distributed ledger) networks. This step ensures that sensitive attributes remain private while enabling trust-based interactions between parties. Therefore, the algorithm 200 may enable the first computing instance 106 in running a flexible software system to generate ZKPs for verifying different kinds of user data. Such processing uses an algorithm that can create custom verification ‘circuits’ depending on what needs to be checked. For example, the algorithm might verify a user's age for age-restricted content or confirm a user's interest in a topic for targeted advertising. Importantly, the actual user data isn't exposed or sent over the network 102—only a proof that says “yes, this data meets the criteria” or “no, it doesn't.” This method ensures user privacy while allowing for accurate and secure data verification.

As described above, the algorithm 200 may enable the first computing instance 106 to configure a predetermined circuit logic for a ZKP, where the circuit logic is representative of an arithmetic computation pertaining to a user data verification process. Correspondingly, the computing instance 106 may run an algorithm capable of programmatically generating specific instances of the predetermined circuit logic based on varying verification criteria and conditions. The computing instance 106 may receive requests for data verification from the computing terminal 104, the second computing instance 108, or other network entities, where each such request includes parameters defining the specific data verification to be performed. The first computing instance 106 may applying the algorithm to the request parameters to dynamically generate a customized instance of the predetermined circuit logic tailored to the specific verification request. The first computing instance 106, the second computing instance 108, or the computing terminal 104 may process the user data to be verified, where the processing adheres to the customized instance of the circuit logic and generates corresponding outputs without disclosing the actual user data. The first computing instance 106 may generate a ZKP (e.g., ZK-SNARK) based on the outputs of the circuit logic, where the proof substantiates the truth of the verification claim (e.g., user attribute validity) without revealing the underlying data. The first computing instance 106 or the computing terminal 104 may transmit the generated ZKP to a verifier entity, such as the second computing instance 108, ensuring the confidentiality of the actual user data throughout the transmission. The second computing instance 108 may verify the authenticity and accuracy of the received ZKP against the same circuit logic instance, thereby confirming the verification claim without accessing the raw user data. The first computing instance 106 may log and store information related to the proof generation and verification processes in a secure and compliant manner for audit and compliance purposes. This approach describes a method where the second computing instance 106 asks the computing terminal 104 over the network 102 for proof that certain information (e.g., age or interest) meets a specific criterion (e.g., being over 18 for age-restricted content). The computing terminal 104 sends the second computing terminal 108 over the network 102 a proof (e.g., a ZKP) that confirms this information without actually sharing the details. The second computing instance 108 then uses this proof to decide what to do next, such as showing a certain ad or unlocking content responsive to validating the proof. The method ensures that the user's personal data is kept private throughout the process. The second computing terminal 108 also collects these proofs to understand larger trends, like what types of content are popular, without ever knowing individual users' data. This method is particularly useful for online services that need to respect user privacy while still delivering personalized experiences or content.

As described above, the algorithm 200 may enable the first computing instance 106 to serve over the network 102 to the computing terminal 104, a request for data verification, where the request is associated with a predetermined verification criterion (e.g., a demographic attribute, an interest, a preference). The first computing instance 106 receives over the network 102 from the computing terminal 104 a ZKP generated based on user data, where the ZKP substantiates compliance with the verification criterion without revealing the actual user data. The first computing instance 106 processes the received ZKP to extract verification results, where the processing adheres to a predetermined cryptographic logic designed for ZKP evaluation. The first computing instance 106 determines an action based on the verification results, where the action aligns with predefined conditions related to the verification criterion. The first computing instance 106 executed the determined action, where the action includes but is not limited to providing access to restricted content, serving targeted advertising, or personalizing user experience, based on the verification result. The first computing instance 106 stores records of the ZKP verification and the executed action in a data structure (e.g., an array, a database table), where the data structure is organized according to a privacy-preserving schema (e.g., Ciphertext Policy Attribute-Based Encryption (CP-ABE), Bloom Filters with Differential Privacy). The first computing instance 106 aggregates anonymized data derived from multiple ZKP verifications to form a dataset for analysis and insights generation. The first computing instance 106 analyzes the aggregated dataset to identify patterns or trends, where the analysis respects the privacy constraints of the ZKPs. The first computing instance 106 updates system configurations or user profiles based on the analysis, to optimize future verifications, content delivery, or user interactions, while maintaining user data confidentiality. The first computing instance 106 generates a comprehensive report based on the aggregated analysis, where the report assists in decision-making or strategy formulation without compromising individual user privacy.

As described above, the algorithm 200 may enable the computing terminal 104 to generate a ZKP for at least one piece of user data, where the ZKP validates a specific attribute or condition of the user data without revealing the actual data. The computing terminal 104 sends the ZKP to the second computing instance 108 over the network 102, where the actual user data remains undisclosed and secured on the computing terminal 104. The second computing instance 108 receives the ZKP from the computing terminal 104 and verifies the ZKP using a predetermined cryptographic verification process to ascertain the validity of the claimed attribute or condition without accessing the underlying user data. The second computing instance 106 determines an appropriate response or action based on the result of the ZKP verification, where the response is tailored to the validated user attribute or condition inferred from the ZKP. The second computing terminal 108 executes the determined response or action, where the execution respects the privacy constraints inherent in the ZKP process and does not utilize the actual user data. The second computing instance 108 logs the occurrence and outcome of the ZKP verification and subsequent response in a data structure (e.g., an array, a table) designed to maintain anonymity and privacy compliance (e.g., via a privacy-preserving schema like a CP-ABE or a Bloom Filter with Differential Privacy). The second computing instance 108 updates its system records (e.g., database records) or status based on the verified user attribute or condition, where these updates contribute to system functionalities or user experience enhancements without compromising user data privacy. The second computing instance 108 aggregates anonymized data derived from multiple ZKP verifications to form insights or analytics, where the aggregation process adheres to privacy-preserving principles. The second computing instance 106 applies insights or analytics derived from aggregated data to refine, optimize, or adapt system functionalities, services, or content delivery, including but not limited to targeted advertising, content personalization, or access control, while ensuring ongoing compliance with data privacy standards. This approach focuses on a method where a central data management platform or database generates ZKP based on stored user data. These proofs are used to validate certain aspects of the data (e.g., age or interests) without revealing the data itself. The ZKPs are then sent to entities that need to verify user information for various purposes (e.g., targeted advertising or access control) without compromising user privacy. The platform also uses the aggregated anonymous data from these proofs to improve its services, ensuring that individual user privacy is preserved throughout the process.

As described above, the algorithm 200 may enable the computing terminal 104 to access user data stored within a database, where such access is via a data management platform (e.g., the first computing instance 106 or the second computing instance 108) and the user data comprises at least one attribute relevant to a specific query or request. The data management platform generates a ZKP based on the user data, where the proof substantiates a particular attribute or condition derived from the user data without revealing or transmitting the actual data. The data management platform transmits proof to a requesting entity (e.g., the second computing instance 108, an advertising server or a verification system), the ZKP over the network 102, ensuring that the actual user data remains undisclosed. The requesting entity receives the ZKP from the data management platform over the network 102 and verifies the ZKP using a predetermined cryptographic process, thereby confirming the validity of the claimed attribute or condition without accessing the underlying user data. The requesting entity executes actions or responses conditionally based on the result of the ZKP verification, where these actions are tailored to the validated user attribute or condition inferred from the proof. The data management platform, system records or statuses in response to the verification result, where these updates contribute to enhanced system functionalities or user experience without compromising data privacy. The data management platform aggregates anonymized data derived from multiple ZKP verifications to form insights or analytics, adhering to privacy-preserving principles. The data management platform applies the insights gained from aggregated data to refine, optimize, or adapt system functionalities, services, or content delivery, while maintaining adherence to data privacy standards.

As described above, the algorithm 200 may enable the first computing instance 106 or the second computing instance 108 may be enabled to implement a decentralized Artificial Intelligence (AI) model (e.g., OpenMined's PySyft) that allows for training on a set of training data distributively stored across a set of physical computing machines and containing a copy of the set of attributes. The decentralized AI model is programmed to generate a set of updates distributively stored on the set of physical computing machines. The ZKP ensure that the set of training data remains confidential external to the AI model relative to a third party computer (e.g., the second computing instance 108) and that only those updates from the set of updates that are necessary for a transaction are shared with the third party computer. The transaction may be associated with the third party computer. The first computing instance may aggregate the set of updates from the set of physical computing machines to update a global AI model and cause the global AI model to be trained without accessing or exposing the set of attributes. The decentralized AI model may receive a consent from the user for data utilization in AI training via a consent management system that records a set of consents on a distributed ledger, associate each tokenized model update with a corresponding user consent record to ensure that only data from consenting users is utilized in training, and update the global AI model only with contributions from users who have provided explicit consent. Note that the first computing instance 106 or the second computing instance 108 may run a reward management software to credit a reward point to the profile for the user providing a consent for the copy of the set of attributes to be used in training the decentralized AI model and the set of updates is generated.

As described above, the algorithm 200 may enable the request to include (e.g., contain) or be logically associated with a first content (e.g., a tracking consent, a category consent) originated from a browser extension running in a browser application program operated by the user, as formed based on a user input into the browser extension or the browser application program on the computing terminal 104, based on the browser application program accessing or attempting to access a web page of a web site, or a section thereof, over the network 102, requesting the set of attributes be verified to serve a second content (e.g., an image, a video, a text, an advertisement) over the network 102 to the browser application program (e.g., in a viewport) sourced from a content exchange (e.g., an image exchange, a video exchange, an ad exchange) hosted on a computing system, as further explained below.

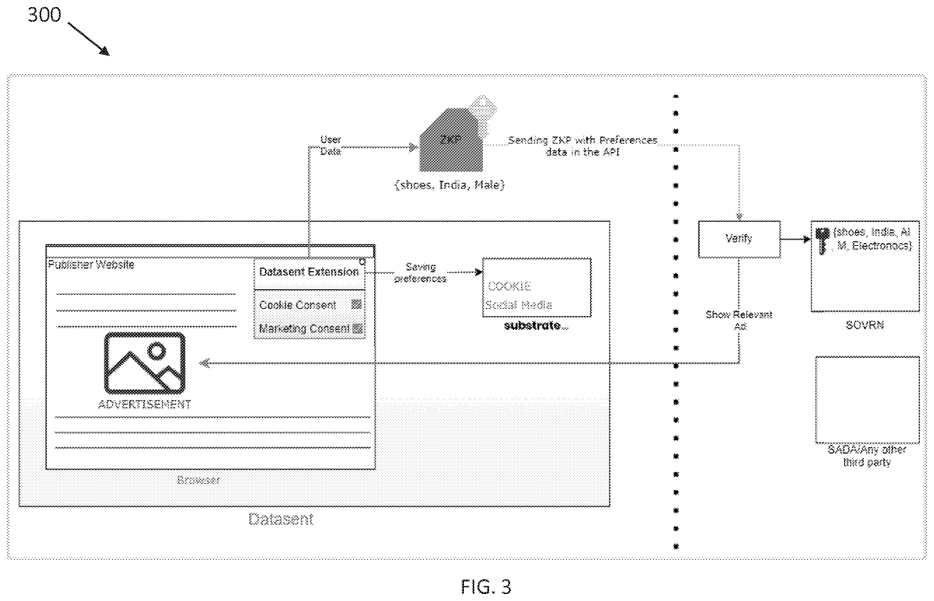

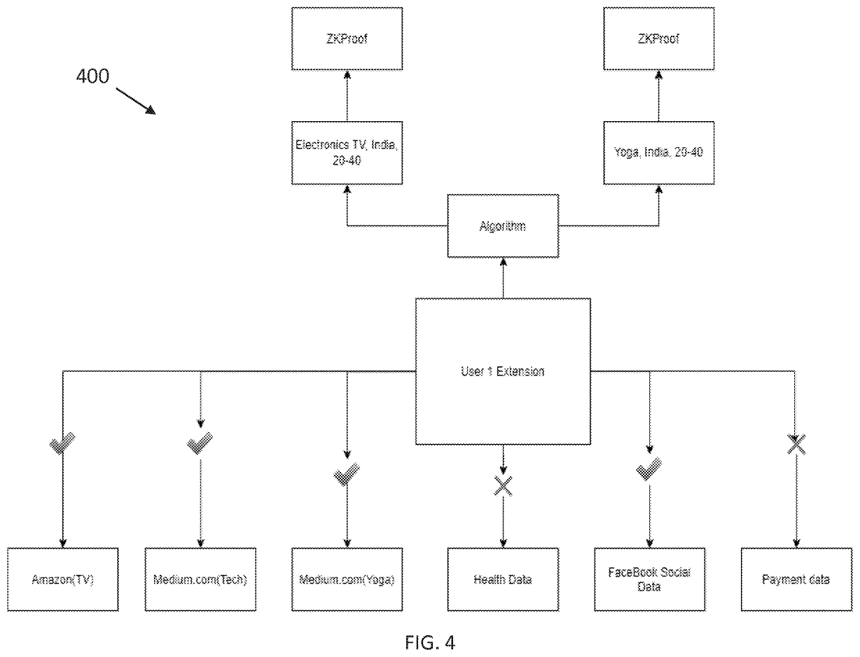

FIG. 3 shows a diagram of an embodiment of a computing arrangement enabling the privacy-preserving service of data based on ZKPs using the computing architecture of FIG. 1 and the algorithm of FIG. 2 according to this disclosure. FIG. 4 shows a diagram of an embodiment of a set of data permissions for the computing architecture enabling the privacy-preserving service of data based on ZKPs using the computing architecture of FIG. 1, the algorithm of FIG. 2, and the computing arrangement of FIG. 3 according to this disclosure. In particular, there is a computing arrangement 300 operative based on a set of data permissions 400 according to the algorithm 200, which may use the computing architecture 100. Resultantly, the computing arrangement 300 is enabled to ensure privacy and security of user data by generating ZKPs for user preference data and real-time sharing those ZKPs over the network 102 with content exchange platforms (e.g., image exchange platforms, video exchange platforms, ad exchange platforms) hosted on third-party computing systems for content service, as described herein. One example of such third-party computing system is the second computing instance 108 (although other suitable computing instances are possible). One example of such ZKPs may be ZK-SNARKs (although other suitable ZKPs are possible).

The computing arrangement 300 may involve the first computing instance 106 and have its software logic as a single software component (e.g., an application program, an applet, a module, an engine that can be started, stopped or paused) or distributed among a set of software components (e.g., application programs, applets, modules, engines that can be started, stopped or paused) hosted on the first computing instance 106. For example, the computing arrangement 300 may have a ZKP generation logic (e.g., an application program, an applet, a module, an engine that can be started, stopped or paused), a ZKP verification logic (e.g., an application program, an applet, a module, an engine that can be started, stopped or paused), and a privacy-preserving data sharing logic (e.g., an application program, an applet, a module, an engine that can be started, stopped or paused), which may be in logical (e.g., signal, data) communication with each other.

The ZKP generation logic may be programmed to generate ZKPs of user preference data (e.g., personal interests) captured from the browser extension installed in the browser application hosted on the OS of the computing terminal 104 over the network 102. The browser extension may be technologically advantageous due to user self-selection (e.g., usage of only those users who want to share their personal preferences), improved security and privacy (e.g., due to user control), seamless integration with browsing (e.g., over remote tracking), lightweight (e.g., in terms of resource usage), cross-platform compatibility (e.g., Edge browser add-ons and Chrome browser add-ons run on Edge browser), enhanced customization of the browser application program, integration with existing software (e.g., other add-ons), or faster development, updates, or maintenance (e.g., given smaller codebase). The ZKP verification logic may be programmed to verify ZKPs generated for the user against the set of content criteria (e.g., image criteria, video criteria, ad criteria) provided by the content exchanges hosted on third-party computing systems for content service, as described herein. The privacy-preserving data sharing logic may be programmed to facilitate sharing of ZKPs with the content exchange platforms hosted on third-party computing systems for content service, to enable delivery of highly relevant content (e.g., images, videos, ads) to users without exposing their actual data, as described herein.

As shown in FIG. 3, the browser extension may be downloaded from a browser extension data source (e.g., a Chrome add-on web portal, a Firefox add-on web portal, a Safari add-on web portal, an Opera add-on web portal) and installed in the browser application program running on the OS of the computing terminal 104. As allowed or permissioned by the browser application program, the browser extension may be programmed to enable the user of the browser application program to provide (e.g., input) their personal preferences (e.g., okay to share my demographic information but not okay to share my payment information) via the browser extension, while browsing webpages (e.g., statically or dynamically generated) of websites. For example, the browser extension may present a prompt (e.g., a window) to query the user whether the user is okay with sharing the user's one type of information (e.g., payment information) when accessing one type of data source (e.g., the user's banking web portal or an e-commerce website). For example, the prompt may be presented within or over a viewport, within or over a menu bar, within or over an address bar, or within or over an icon in a menu bar or an address bar in the browser application program. For example, the prompt may include a user input element (e.g., a radio button, a checkbox, a dropdown menu), along with a corresponding label, requesting a corresponding user input (e.g., binary, share or not share) for permission or lack thereof to share a particular attribute or a set of attributes, as described herein. For example, the browser extension may save the user preference as a cookie, whether as a single cookie or a set of cookies, for access by the browser application program. For example, the user preferences may be captured via the browser extension and then sent, whether as a one-time payload or a series of payloads, from the browser extension for storage to a node of a blockchain (e.g., public, private, hybrid). If update is desired (e.g., user changed his mind), then all or some (e.g., by sending differences) attributes may be sent from the browser extension for storage on the node of the blockchain.

Once the browser extension obtains the user preferences, the browser extension starts to capture user preference data stored on the computing terminal 104. If the user switches from the computing terminal 104 to another computing terminal (e.g., from desktop computer to laptop computer), then the user preference data will also be changed to maintain or maximize the user's privacy, i.e., not shared between the computing terminal 104 and another computing terminal. However, note that this configurations is not required and there may be a centralized data source enabling for sharing of such data, i.e., synchronize between the computing terminal 104 and another computing terminal.

As shown in FIG. 4, the user data comprises user engagements on various webpages of websites, captured by the browser extension based on the user preferences. For example, the user may operate the browser application program to visit Amazon.com (or another website) and explore the “Television” category, as captured (e.g., tracked) by the browser extension. Likewise, the user may operate the browser application program to visit medium.net (or another website) and navigate to categories, such as “Tech Yoga,” “Health Data,” “Facebook,” and “Payment Data,” as captured (e.g., tracked) by the browser extension. Therefore, the green checkmarks in FIG. 4 represent the permissions or preferences (e.g., categories) the user has allowed for data tracking by the browser extension. Note that the browser extension cannot track information for which the user has not provided consent. Therefore, the algorithm 200 may be programmed to decide and prioritize a specific string, JSON (or another suitable hierarchical data structure) or categorization of user preferences to track only what the user has allowed (e.g., permissioned) via the browser extension. For example, the user operates the browser extension or the browser application program to spend 20% (or another time period whether more or less) of his or her time, as measured by the browser extension against the total time usage of the browser extension or the browser application program on a per time period (e.g., since installation of the browser application, daily, weekly, monthly) basis, just looking for a television on Amazon. com. Therefore, the algorithm 200 would decide, that this user is interested in electronics TV, he's from India, and his age range is between 20 and 40. Accordingly, these are two categories that the algorithm 200 has decided, probably the higher priorities for electronics, because this is where he is spending most of his time.

In terms of service of content (e.g., images, videos, text, ads) from content exchange platforms (e.g., image exchange platforms, video exchange platforms, ad exchange platforms) hosted on third-party computing systems, such as the second computing instance 108, the content may be served, which may be in real-time, by one of such third-party computing systems (e.g., Sovrn) requesting the categorization through an Applicant Programming Interface (API), which may be RESTful, hosted on the first computing instance 106, from the first computing instance 106 over the network 102. In response, the first computing instance 106 will create a ZKP of user data, as described above, which will be then be sent to the third-party computing system over the network 102, along with user categorization, which may include a unique user identifier generated by the browser extension or the first computing instance 106. In response, the third-party computing system will verify this ZKP and categorization. As such, the third-party computing system now knows and is confident (e.g., 100%) that this information is coming from the first computing instance 106 and the first computing instance 106 has given suitable proof (e.g., I have proof of whatever information I am providing). Therefore, the third-party computing system will verify if the ZKP provided from the first computing instance is true and will start serving a content (e.g., an image, a video, a text, an advertisement) relevant to this specific categorization to the computing terminal 104. Since this back-and-forth may occur in real-time, the ZKP may be embodied as a ZK-SNARK, which is technologically advantageous due to zero-knowledge, succinctness, non-interactivity (e.g., does not require back-and-forth communication between a prover and a verifier and a single message from the prover suffices), and argument of knowledge. If there is a need to add a new third-party computing system hosting a new content exchange, then this process may remain similar as described above, other than what API the new third-party computing system will identify for provision of requests for a particular type of data (e.g., categorization). Therefore, the computing arrangement 300 and the set of data permissions 400 enable the secure and privacy-preserving sharing of user preference data with content exchanges (e.g., image exchanges, video exchanges, ad exchanges) through ZKPs.

Appended to this Detailed Description is a paper drafted by Datasent, Inc. and named “Mathematical Framework and Proof for Training LLMs with Tokenized Circuit Logic Features.” The paper is incorporated by reference herein for all purposes. As such, the paper further describes additional technologies and use cases enabled with subject matter disclosed in this Detailed Description. In particular, the paper describes the use of tokenized arithmetic circuit logic features for training AI models in a privacy-preserving manner, with focus on language models, such as large language models (LLMs), but is applicable to any AI or machine learning algorithm. The approach disclosed in the paper ensures data privacy by transforming raw data into tokenized outputs from arithmetic circuit logic computations (primarily used in ZKP applications), while addressing the loss of granularity by incorporating multi-attribute feature extraction, hierarchical representations, and context-aware refinement.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to be-come coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network, a neutrino network, an optical network (e.g., Li-Fi, fiberoptics), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of this disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required be-fore, after, and/or concurrently with example embodiments, as disclosed herein. Note that any and/or all methods and/or processes, at least as disclosed herein, can be at least partially performed via at least one entity or actor in any manner.

Although preferred embodiments have been depicted and described in detail herein, skilled persons know that various modifications, additions, substitutions and the like can be made without departing from spirit of this disclosure. As such, these are considered to be within the scope of the disclosure, as defined in the following claims.

What is claimed is:

1. A method, comprising:
receiving, by a processing unit, a request to enable a verification of an attribute of a set of attributes of a profile of a user;
parsing, by the processing unit, the request into a set of tokens responsive to the processing unit receiving the request;
generating, by the processing unit, a hierarchical data structure;
populating, by the processing unit, the hierarchical data structure with the set of tokens;
generating, by the processing unit, a circuit logic based on the set of tokens read from the hierarchical data structure, wherein the circuit logic embodies a set of computations to verify the set of attributes;
solving, by the processing unit, a computation of the set of computations for the attribute such that a result related to the verification is formed;
comparing, by the processing unit, the result to the attribute or vice versa;
generating, by the processing unit, a Zero-Knowledge Proof (ZKP) related to the verification for the result matching the attribute or vice versa without accessing the set of attributes;
granting, by the processing unit, an access to the ZKP such that the attribute is verifiable based on the ZKP without accessing the set of attributes; and
taking, by the processing unit, an action related to the verification based on the access without accessing the set of attributes responsive to the processing unit receiving the request.

2. The method of claim 1, wherein the hierarchical data structure is an abstract syntax tree (AST).

3. The method of claim 1, wherein the hierarchical data structure is other than an abstract syntax tree (AST).

4. The method of claim 3, wherein the hierarchical data structure is a concrete parse tree (CPT).

5. The method of claim 3, wherein the hierarchical data structure is a concrete syntax tree (CST).

6. The method of claim 1, wherein the ZKP is non-interactive.

7. The method of claim 1, wherein the set of computations has a one-to-many correspondence with the set of attributes.

8. The method of claim 1, wherein the set of computations has a one-to-one correspondence with the set of attributes.

9. The method of claim 1, wherein the set of computations has a many-to-many correspondence with the set of attributes.

10. The method of claim 1, wherein the set of computations has a many-to-one correspondence with the set of attributes.

11. The method of claim 1, wherein the result is compared to the attribute.

12. The method of claim 1, wherein the attribute is compared to the result.

13. The method of claim 1, wherein the result matches the attribute.

14. The method of claim 1, wherein the attribute matches the result.

15. The method of claim 1, wherein the processing unit is a physical server machine, wherein the request is sent by a physical client machine operated by the user.

16. The method of claim 1, wherein the processing unit is a single processing unit.

17. The method of claim 1, wherein the processing unit is a set of processing units.

18. The method of claim 1, further comprising:
authenticating, by the processing unit, the ZKP before the access is granted.

19. The method of claim 18, wherein the ZKP is authenticated by comparing the ZKP to the circuit logic or vice versa.

20. The method of claim 19, further comprising:
writing, by the processing unit, a content into a log memorializing the ZKP being authenticated.

21. The method of claim 1, wherein the action includes integrating, by the processing unit, the ZKP with a record for the user on a distributed ledger such that a consent by the user related to the set of attributes is recorded in the record.

22. The method of claim 21, further comprising:
causing, by the processing unit, a browser extension or a web application to interface with a user application hosted on an operating system of a physical client machine sourcing the request such that the browser extension or the web application present a notice related to the ZKP in the user application.

23. The method of claim 22, wherein the browser extension or the web application is programmed to read the consent in the record, generate a copy of the consent, and present the copy in the user application for review by the user.

24. The method of claim 23, wherein the record is a first record, wherein the copy is modifiable by the user in the user application such that the copy as modified by the user in the user application is recordable in a second record on the distributed ledger after the first record.

25. The method of claim 22, wherein the browser extension or the web application is programmed to dynamically render a user interface in the user application based on the attribute being verified.

26. The method of claim 22, further comprising:
causing, by the processing unit, the verification of the ZKP with the record be performed such that the ZKP logically aligns with the consent.

27. The method of claim 26, wherein the ZKP is a first ZKP, wherein the verification is a first verification, wherein the distributed ledger is programmed to support a real-time update to the consent to allow for a second verification of a second ZKP based on the real-time update.

28. The method of claim 26, wherein the browser extension or web application is programmed to notify the user application of a first result of the first verification and a second result of a second verification, wherein the action is based on the first result and the second result.

29. The method of claim 22, wherein the browser extension or the web application is programmed to receive an input from the user in the user application, wherein the processing unit and the browser extension or the web application coordinate such that the input is logically reflected in the ZKP.

30. The method of claim 1, further comprising:
causing, by the processing unit, a machine of an operator of a website to act as a prover for the ZKP, wherein the website is associated with a data storage system providing an input for generating the ZKP.

31. The method of claim 30, wherein the data storage system includes a database system, a customer relationship management (CRM) system, a content management system (CMS), a consent management platform (CMP), or a data management platform (DMP), wherein the data storage system stores a set of user data for a set of users, wherein the set of user data includes a demographic information, a set of user preferences, or a set of consent records, wherein the set of user data includes the profile, wherein the set of users includes the user.

32. The method of claim 31, wherein the ZKP is generated based on the processing unit interfacing with the data storage system such that the set of user data is not shared with the processing unit.

33. The method of claim 32, wherein the data storage system includes the processing unit.

34. The method of claim 33, further comprising:
validating, by the processing unit, the ZKP such that the profile is logically consistent with a set of specified criteria for a targeted service or an advertising campaign without revealing the set of user data to a machine of an operator of the targeted service or the advertising campaign.

35. The method of claim 33, wherein the machine of the operator of the website is capable of using an outcome of validating the ZKP to customize a user experience of the website based on the set of user data that has been verified, wherein the user experience includes a personalized content delivery or a targeted advertisement.

36. The method of claim 32, wherein the data storage system and the processing unit are synchronized such that the ZKP is generated based on the attribute being up-to-date.

37. The method of claim 32, wherein the processing unit enables the data storage system to provide a user interface to manage the request enabling the ZKP to be generated.

38. The method of claim 1, further comprising:
implementing, by the processing unit, a decentralized Artificial Intelligence (AI) model that allows for training on a set of training data distributively stored across a set of physical computing machines and containing a copy of the set of attributes, wherein the decentralized AI model is programmed to generate a set of updates distributively stored on the set of physical computing machines;
causing, by the processing unit, the ZKP to ensure that the set of training data remains confidential external to the AI model relative to a third party computer and that only those updates from the set of updates that are necessary for a transaction are shared with the third party computer, wherein the transaction is associated with the third party computer;
aggregating, by the processing unit, the set of updates from the set of physical computing machines to update a global AI model; and
causing, by the processing unit, the global AI model to be trained without accessing or exposing the set of attributes.

39. The method of claim 38, wherein the decentralized AI model:
receives a consent from the user for data utilization in AI training via a consent management system that records a set of consents on a distributed ledger;
associates each tokenized model update with a corresponding user consent record to ensure that only data from consenting users is utilized in training; and
updates the global AI model only with contributions from users who have provided explicit consent.

40. The method of claim 38,
running, by the processing unit, a reward management software to credit a reward point to the profile for the user providing a consent for the copy of the set of attributes to be used in training the decentralized AI model and the set of updates is generated.

41. The method of claim 1, wherein the request includes or is associated with a first content originated from a browser extension running in a browser application operated by the user based on the browser application accessing or attempting to access a webpage requesting the set of attributes be verified to serve a second content to the browser application program.

42. The method of claim 1, wherein the ZKP is a Zero-Knowledge Succinct Non-Interactive Argument of Knowledge (ZK-SNARK).

43. The method of claim 1, wherein the ZKP is a Zero-Knowledge Scalable Transparent Argument of Knowledge (ZK-STARK).
